(19) United States
(12) Patent Application Publication
(10) Pub. No.: US 2007/0015470 A1
(43) Pub. Date: Jan. 18, 2007

(54) Method for the estimation of data units transmitted in a radio block via a radio channel and receiving station

(76) Inventors: Jurgen Gotze, Dortmund (DE); Christian Vincent Sinn, Hotzwickede (DE)

Correspondence Address: STAAS & HALSEY LLP, SUITE 700, 1201 NEW YORK AVENUE, N.W., WASHINGTON, DC, 20005, US

(21) Appl. No.: 10/560,379

(22) PCT Filed: May 5, 2004
(86) PCT No.: PCT/EP04/50709

§ 371 Date: Dec. 13, 2005

(30) Foreign Application Priority Data
Jun. 13, 2003 (DE) 103 26 810.3

(51) Int. Cl. H04B 7/00; H04B 1/00

(52) U.S. Cl. 455/70

(57) ABSTRACT

The invention relates to a method for estimating data units (d11, d12, d13, d14, d21, d22, d23, d24) transmitted in a radio block (d) via a radio channel. Based on the transmitted data units (d11, d12, d13, d14, d21, d22, d23, d24), a signal sequence (S) is received by a receiving station (BS). The components of the received signal sequence (S) are assigned in the temporal sequence of the reception thereof to at least one first and one second signal block (X1, X2, X3) and are processed in blocks. The signal blocks (X1, X2, X3) overlap in such a manner that at least one component of the received signal sequence belongs to the two signal blocks (X1, X2, X3) and estimation values for the transmitted data units (d11, d12, d13, d14, d21, d22, d23, d24) are determined based on the components of both signal blocks (X1, X2, X3).

### CROSS REFERENCE TO RELATED APPLICATIONS

This application is based on and hereby claims priority to PCT Application No. PCT/EP2004/050709 filed on May 5, 2004 and German Application No. 10326810.3 filed on Jun. 13, 2003, the contents of which are hereby incorporated by reference.

### BACKGROUND OF THE INVENTION

The invention relates to a method for estimating data units transmitted in a radio block via a radio channel, together with a corresponding receiving station.

In radio communication systems, data (for example speech, image data or other data) is transmitted between a base station and a mobile station via a radio interface, using electromagnetic waves. In doing so, the electromagnetic waves are radiated with a carrier frequency which lies within a frequency band provided for the system concerned.

The basic principle of multi-carrier methods relates to dividing up high bit-rate data streams into a number of streams with a lower bit-rate. These streams with the lower bit-rate are transmitted simultaneously over a number of sub-carriers. For this transmission, inter-symbol interference (ISI) and cross-talk between the sub-carriers (inter-carrier interference, ICI) arise. One possible way of counteracting the cross-talk between sub-carriers relates to using orthogonal sub-carriers with separate frequencies. In general, inter-symbol interference can be entirely eliminated by adding to each symbol a protective time interval (guard period). The symbol is cyclically expanded in the guard period, to avoid any cross-talk between the sub-carriers. If there is any cross-talk between the sub-carriers, this means that the sub-carriers are not orthogonal to each other.

The OFDM (Orthogonal Frequency Division Multiplex) method represents a variant of the multi-carrier method with orthogonal frequency-separated sub-carriers. Inter-symbol interference is caused by multi-path propagation. In the case of OFDM-based data transmission in radio communication systems, an OFDM symbol is produced by the modulation of user data onto sub-carriers. This is effected by the application of the inverse fast-Fourier transform (IFFT) to the user data. Following this, either a cyclic prefix (CP) is added before each symbol or 0 data is appended to each symbol (zero padding, ZP). Successive OFDM symbols can interfere as a result of multi-path propagation on the radio channel.

In order to retrieve the user data from the received data, the following methods can be used: in the case of CP, parts of the received symbol are ignored, so that neighboring OFDM symbols are as interference-free as possible. The fast-Fourier transform (FFT) is applied to the remaining data for an OFDM symbol and this is then allocated to the relevant sub-carrier frequency as determined by the value of the transfer function of the radio channel. By doing so, the user data can be retrieved.

The ZP case can be reduced to the CP case by appropriate addition of the received data, so that the data can be retrieved in the same way. Furthermore, in the ZP case the user data can be estimated by using suitable criteria—such as for example least squares (LS) or minimum mean square error (MMSE)—to solve an overspecified system of equations.

The benefit of CP lies in the fact that neighboring OFDM symbols do not interfere and there is no cross-talk between the sub-carriers if a long enough CP is chosen, that is at least as long as the maximum channel delay (delay spread, DS). As in the case of CP or ZP, the insertion of guard periods results in a reduction in the effective data transmission rate for user data. Furthermore, in the case of CP a substantial part of the transmission capacity is used for transmitting a CP, which is especially unwanted in mobile transmission methods. In radio systems conforming to Hiperlan/2 (High Performance Radio Local Area Network Type 2), the CP amounts to 20% of the time for an OFDM symbol.

As in the case of CP or ZP, the insertion of guard periods results in a reduction in the effective data transmission rate for user data. Furthermore, in the case of CP a substantial part of the transmission capacity is used for transmitting a CP, which is especially unwanted in mobile transmission methods. In radio systems conforming to Hiperlan/2 (High Performance Radio Local Area Network Type 2), the CP amounts to 20% of the time for an OFDM symbol.

U.S. Pat. No. 6,345,076 B1 describes a method for the incoherent receipt of differentially modulated data. Symbols which are received are estimated using an incoherent MLSE (maximum likelihood sequence estimation). For the purpose of improving the reception quality, the symbols which are received are subdivided into overlapping symbol blocks, which overlap by at least one symbol. Because, in the case of differentially modulated data, the items of data which are to be transmitted are not contained in the individual symbols but in the phase changes of neighboring symbols, the overlapping of the symbol blocks is required so that there is a reference phase for each symbol in a symbol block.

Hence, one possible object underlying the invention is to specify an advantageous method for data estimation which makes possible the transmission of data units without guard periods.

### SUMMARY OF THE INVENTION

The inventors propose a method for estimating data units transmitted in a radio block via a radio channel, a signal sequence arising from the data units which are transmitted is received in a receiving station. The components of the signal sequence which is received are assigned to at least a first and a second signal block in the time-sequence of their receipt, and are processed block-by-block, with the signal blocks overlapping in such a way that at least one component of the received signal sequence belongs to both signal blocks, and by reference to the components of both signal blocks estimated values are determined for the data units which were transmitted. The use of overlapping signal blocks for the estimation of the transmitted data units makes it possible to forgo a guard period signal blocks estimated values are determined for the data units which were transmitted. The use of overlapping signal blocks for the estimation of the transmitted data units makes it possible to forgo a guard period between individual data units. In particular, several radio blocks can be transmitted in succession with no guard periods, and can be analyzed, i.e. estimated, by the receiving station.

It is advantageous if the overlap of the signal blocks is effected in such a way that in each case there is at least one transmitted data unit for which an estimated value can be determined by reference to both signal blocks. For this at least one transmitted data unit it is possible to use, for example, an average of the estimated values, and thus to achieve improved estimation.

In a preferred development, after determination of the two estimated values, the estimated value determined by reference to one of the two signal blocks is used exclusively for the at least one transmitted data unit. If one of the two estimated values is significantly worse than the other estimated value, that estimated value which has the largest error is discarded. In this case, the choice of one of the two estimated values permits a better estimate than would be possible, for example, by averaging or by methods which supply only one estimated value for the at least one transmitted data unit.

In one form of embodiment, a cyclic transfer matrix is assigned in each case to the signal blocks, and the estimated values are calculated by multiplication of the signal blocks by the relevant inverse transfer matrix. The use of a cyclical transfer matrix or the relevant inverse transfer matrix enables a particularly simple calculation of the estimated values.

In an alternative form of embodiment, a transfer matrix with a Töplitz structure and a band structure is assigned in each case to the signal blocks, and the estimated values are calculated by multiplication of the signal blocks with the relevant pseudo-inverse transfer matrix. The use of a transfer matrix with a Töplitz structure and a band structure, or the corresponding pseudo-inverse transfer matrix, as applicable, has the advantage that the transfer matrix has full column rank, which thus ensures that the pseudo-inverse transfer matrix always exists. Furthermore, with the use of a pseudo-inverse transfer matrix for the calculation of the estimated values it is possible to achieve error rates for the estimated values of the transmitted data units which are just as low as for data transmissions in which guard periods are inserted in the familiar way between individual data units or individual radio blocks, as applicable. It is thus possible to achieve a higher data transmission rate than with known systems but with no losses in transmission quality.

The inventors also propose a receiving station having all the characteristics necessary for carrying out the method.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a schematic data transmission from a transmitting to a receiving station,

FIG. 2 shows a first matrix representation of the estimation of data in accordance with one embodiment of the invention,

FIG. 3 shows a second matrix representation of the estimation of data in accordance with one embodiment of the invention,

FIG. 4 shows a third matrix representation of the estimation of data in accordance with one embodiment of the invention,

FIG. 5 shows block error rates as a function of the signal-to-noise ratio for data estimates made in accordance with one embodiment of the invention, using various parameters.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

In these figures, identical items are given the same reference characters.

A receiving station is any station which can receive signals. In what follows a base station is regarded as a receiving station. A receiving station can also be a mobile station. A mobile station is, for example, a mobile telephone or even a device for the transmission of image and/or sound data, for sending faxes, Short Message Service (SMS) messages and e-mails, and for accessing the Internet, which can be moved from one location to another. It is thus a general receiving unit in a radio communication system.

The Method and receiving station can be used to advantage in any arbitrary radio communication systems. The term radio communication systems is to be taken as any arbitrary system in which data transmission is effected between stations via a radio interface. The data can be transmitted either bi-directionally or uni-directionally. Radio communication system are, in particular, mobile radio systems conforming for example to the GSM (Global System for Mobile Communication) or UTMS (Universal Mobile Telecommunication System) standards. Future mobile radio systems, for example fourth generation and multiple carrier systems using an OFDM method or single carrier systems using a cyclic prefix (CP) or 0-data (ZP), are also to be considered as radio communication systems.

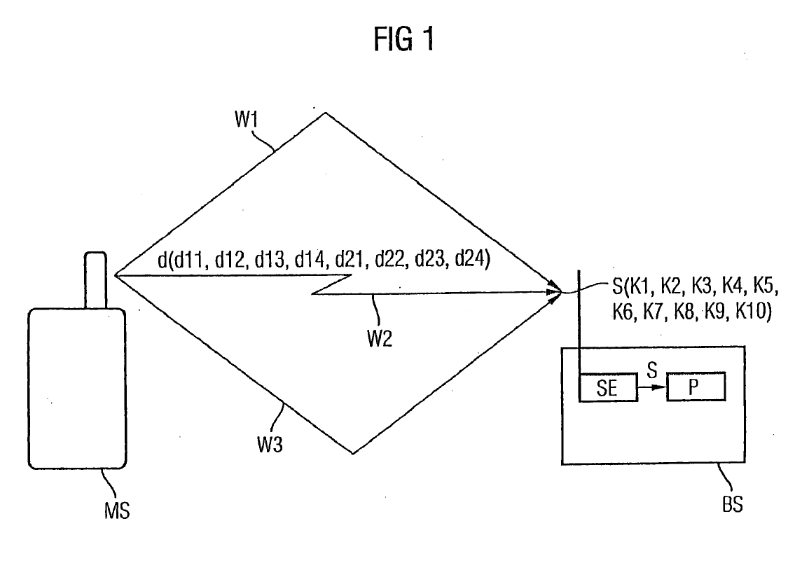

FIG. 1 shows in schematic form a data transmission from a transmitting station MS to a receiving station BS. The transmitting station MS transmits a radio block d, which has eight data units d11, d12, d13, d14, d21, d22, d23, d24, over a radio channel to the receiving station BS. Due to multi-path propagation, for example via the three paths W1, W2, W3, the receiving station BS receives a signal sequence S having ten components K1, K2, K3, K4, K5, K6, K7, K8, K9, K10. The receiving station BS has a transmit and receive unit SE together with an analysis unit P for storing the signal sequence S which it has received and for estimating the data units d11, d12, d13, d14, d21, d22, d23, d24 which were transmitted. The radio channel can be specified by a channel pulse response h, having in this example the three components h1, h2, h3, i.e. it has a length L=3. Here, the length L=3 means that the data unit d11 which is the first to be sent interferes with the following two data units which are transmitted, due to multi-path propagation. The effect of the radio channel on the transmission of the radio block d can be described mathematically by a system matrix H determined by the channel pulse response h.

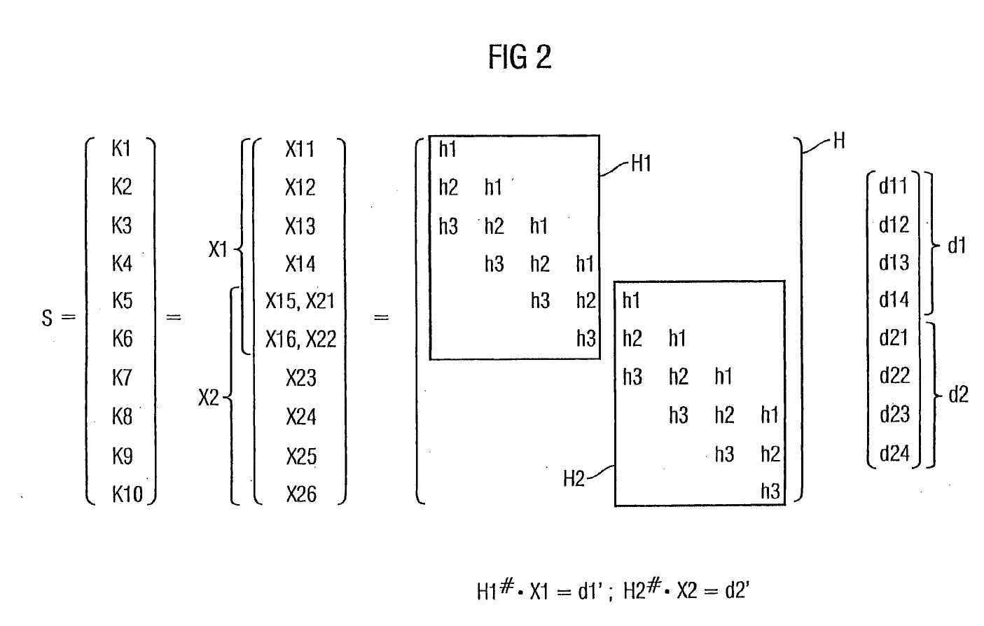

FIG. 2 shows a matrix representation of the data transmission from the transmitting station BS to the receiving station BS. The signal sequence S which is received can be expressed as the product of the system matrix H and the radio block d. The components K1, K2, K3, K4, K5, K6, K7, K8, K9, K10 of the signal sequence S contain the effects of interference between the transmitted data units d11, d12, d13, d14, d21, d22, d23, d24. The time sequence of the receipt of the components K1, K2, K3, K4, K5, K6, K7, K8, K9, K10 of the signal sequence S corresponds to their numbering from one to ten.

For the purpose of estimating the data units d11, d12, d13, d14, d21, d22, d23, d24 which have been transmitted, the receiving station BS forms a first signal block X1 using the components X11, X12, X13, X14, X15, X16 from the first six components K1, K2, K3, K4, K5, K6 of the signal sequence S, and second signal block X2 using the components X21, X22, X23, X24, X25, X26 from the last six components K5, K6, K7, K8, K9, K10 of the signal sequence S. The last two components X15, X16 of the first signal block X1 then correspond to the first two components X21, X22 of the second signal block X2, i.e. X15=X21 and X16=X22. A transfer matrix H1, H2 is assigned to each of the two signal blocks X1, X2. The multiplication of the relevant transfer matrix H1, H2 by the first or the second transmission block d1, d2 of the data units d11, d12, d13, d14, d21, d22, d23, d24 which have been transmitted gives in each case the first and the second signal block X1, X2 respectively, ignoring the interference between the two transmission blocks d1, d2. The first transmission block d1 has the first four data units d11, d12, d13, d14 in the radio block d, and the second transmission block d2 has the last four data units d21, d22, d23, d24 in the radio block d.

The naming of the components in the transmission blocks and the signal blocks has been chosen so that the first number permits its assignment to the appropriate block, while the second number specifies its position within the block. X13 is thus the third component X13 of the first signal block X1.

Both the system matrix H and also the transfer matrices H1, H2 have a Töplitz structure and band structure, i.e. they have full column rank and a pseudo-inverse transfer matrix always exists for these transfer matrices. A matrix has a band structure if a triangular portion of it on the top right and a triangular portion of it on the bottom left contain only zeros. A matrix has a Töplitz structure if all the components within the diagonals have the same value.

The receiving station BS now estimates the data units d11, d12, d13, d14 which were transmitted in the first transmission block d1 by multiplying the first signal block X1 by the pseudo-inverse transfer matrix H1# of the first transfer matrix H1. In a similar fashion, the data units d21, d22, d23, d24 which were transmitted in the second transmission block d2 are estimated by multiplying the second signal block X2 by the pseudo-inverse transfer matrix H2# of the second transfer matrix H2. Then: H1#*X1=d1′ and H2#*X2=d2′. Here, d1′ and d2′ are the estimated transmission blocks d1′ and d2′, i.e. the estimated values for the transmitted data units d11, d12, d13, d14, d21, d22, d23, d24 of the radio block d.

The method makes it possible to omit guard periods in systems which until now have used guard periods between transmission blocks, such as for example OFDM systems or block-based individual carrier systems with a cyclic prefix (CP) or 0-data (ZP), as applicable. In the exemplary embodiment described for FIG. 2, interference between the two transmission blocks d1, d2 does indeed increase because a guard interval has been omitted, but the transmission capacity, i.e. the data transmission rate, is increased.

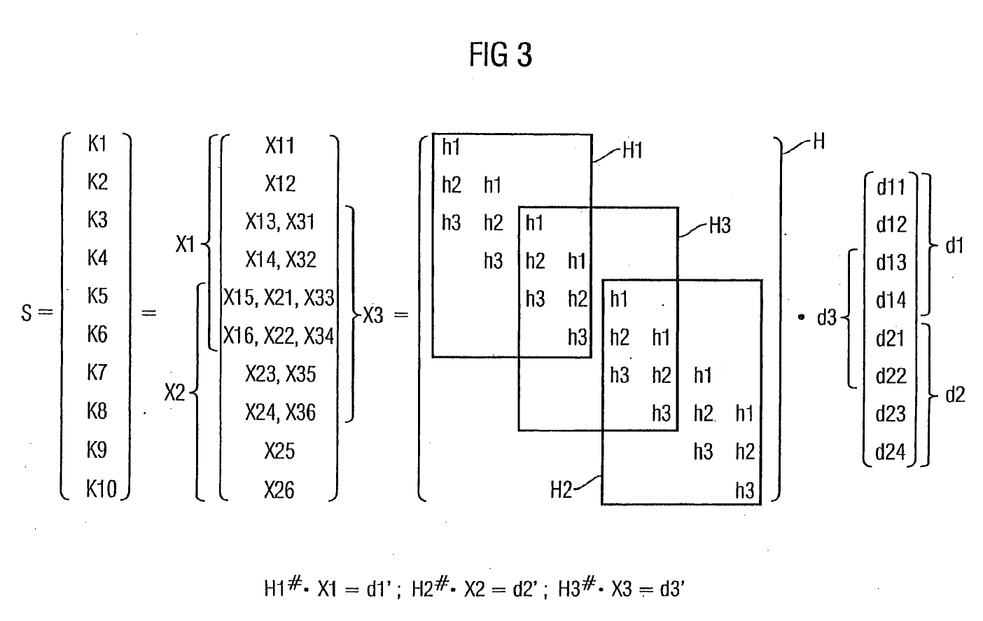

In order, furthermore, to eliminate the effects of interference between the transmission blocks d1, d2 which are transmitted as one radio block d, i.e. without guard periods, when estimating the data units d11, d12, d13, d14, d21, d22, d23, d24 which have been transmitted, a special formation of the signal blocks is used in a form of embodiment as shown in FIG. 3.

FIG. 3 shows in schematic form the special formation of the signal blocks which enables an estimate to be made, of the data units d11, d12, d13, d14, d21, d22, d23, d24 which were transmitted, which has error rates such as have until now only been achieved with the use of guard periods.

The radio block d, which has already been described for FIGS. 1 and 2, is transmitted over the same radio channel with the channel pulse response h with its length of L=3, and leads in turn to the receipt of a signal sequence S.

For the purpose of estimating the data units d11, d12, d13, d14, d21, d22, d23, d24 transmitted in the radio block d, three signal blocks X1, X2, X3 are now formed. The first two signal blocks X1, X2 are the same signal blocks X1, X2 as already described for FIG. 1. The third signal block X3 with its components X31, X32, X33, X34, X35, X36 is formed from the second to the eighth components K2, K3, K4, K5, K6, K7, K8 of the signal sequence S, and thus matches the last four components X13, X14, X15, X16 of the first signal block X1 and the first four components X21, X22, X23, X24 of the second signal block X2. Consequently: X31=X13, X32=X14, X33=X15=X21, X34=X16=X22, X35=X23 and X36=X24.

This formation of the signal blocks X1, X2, X3 can be represented as three overlapping transmission blocks d1, d2, d3, to each of which is assigned a transfer matrix H1, H2, H3. These virtual transmission blocks are not transmitted, but are used in describing the method. The radio block d is what is transmitted.

To the first and second signal blocks X1, X2 are assigned the transfer matrices H1, H2 previously described. The third signal block X3 has a third transfer matrix H3, which overlaps the first and second transfer matrices H1, H2.

For each transfer matrix H1, H2, H3 the receiving station BS now forms the associated pseudo-inverse transfer matrix H1#, H2#, H3# and multiplies this by the corresponding signal block X1, X2, X3. From the first signal block X1 is derived a first estimated transmission block d1′ with estimated values for the first four data units d11, d12, d13, d14 which were transmitted in the radio block d. The second signal block X2 provides a second estimated transmission block d2′ with estimated values for the last four data units which were transmitted, d21, d22, d23, d24. The third signal block X3 gives a third estimated signal block d3′ with estimated values for the third to the sixth data units which were transmitted, d13, d14, d21, d22, i.e. for the last data units d13, d14 which were transmitted in the first transmission block d1 and for the first two data units d21, d22 which were transmitted in the second transmission block d2. Due to the interference effects between the data units in the transmission blocks d1, d2, d3, the first and last estimated values of the data units transmitted for the transmission blocks d1, d2, d3 exhibit the largest errors. For the first transmission block d1, these are the components d11 and d14, for the second transmission block d2 they are the components d21 and d24, and for the third transmission block X3 the components d13 and d22. Consequently, the best estimate of the transmitted data units d1, d12, d13, d14, d21, d22, d23, d24 is obtained if the estimated values with the largest errors are not used. Hence, for the first three data units transmitted, d11, d12, d13, the estimated values used are those which have been determined by reference to the first signal block X1. The fourth and fifth data units transmitted, d14, d21, are determined by reference to the third signal block X3, while the sixth to eighth data units transmitted, d22, d23, d24, are determined by reference to the second signal block X2. It is particularly advantageous if other radio blocks are transmitted continuously before and after the radio block d. It is possible in this way to form further signal blocks which overlap respectively with the first or the second signal blocks, X1, X2 in the same way as does the signal block X3. The first and the last data units transmitted, d11, d24, can then be estimated using those additional signal blocks which overlap respectively with the first and the second signal blocks, X1, X2. The result of doing so is an improved estimate for the first and the last data units transmitted, d11, d24.

With a continuous data transmission it is possible, i.e. by the use, as applicable, of overlapping signal blocks or overlapping transfer matrices or overlapping (virtual) transmission blocks, to estimate all the data units transmitted just as well as has until now been possible only by the use of guard periods between the data units transmitted or between (real) transmission blocks or between radio blocks, as applicable.

It is, of course, also possible to form larger signal blocks with more than six components, for example with 32 or 64, or the overlap of the signal blocks can be larger than four components, as appropriate. Furthermore, there can be other channel pulse responses, with lengths greater than three. Even under transmission conditions which differ in these ways, the method can be applied in the same way.

Instead of assigning transfer matrices with Töplitz structures and band structures, it is also possible to assign cyclic transfer matrices to the overlapping signal blocks. With these, the calculation is easier than with Töplitz transfer matrices, but with Töplitz transfer matrices it is possible to achieve lower error rates than with cyclic transfer matrices.

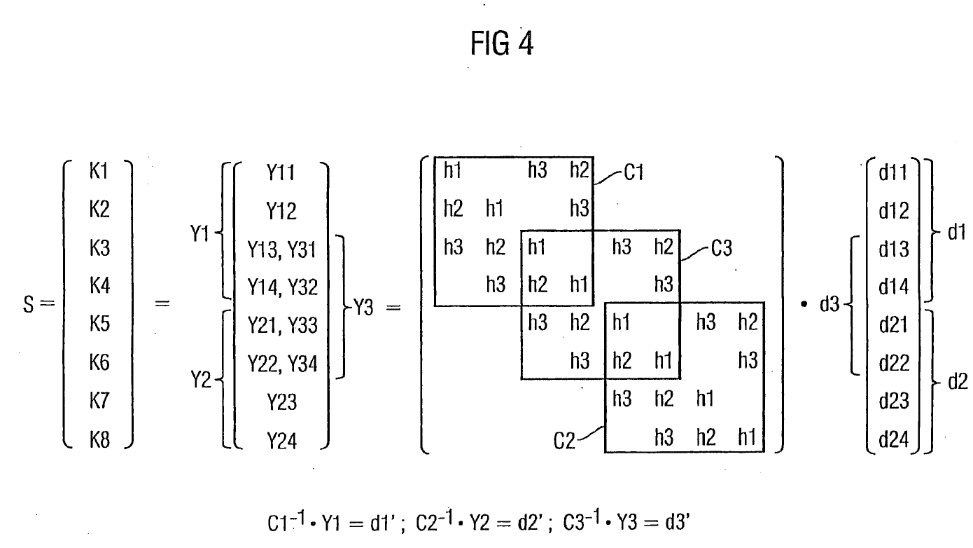

FIG. 4 shows the assignment of cyclic transfer matrices C1, C2, C3 to corresponding overlapping signal blocks Y1, Y2, Y3 for the transmission of the radio block d from FIG. 2 or FIG. 3, as applicable. A first signal block Y1 with the components Y11, Y12, Y13, Y14 has the first four components K1, K2, K3, K4 of the signal sequence S. A second signal block Y2 with the components Y21, Y22, Y23, Y24 has the fifth to the eighth components K5, K6, M7, M8 of the signal sequence S, while a third signal block Y3 with the components Y31, Y32, Y33, Y34 has the third to the sixth components K3, K4, K5, K6 of the signal sequence S. Then: Y13=Y31, Y14=Y32, Y21=Y33 and Y22=Y34. The last two components K9, K10 of the signal sequence S are not used until a signal block, which overlaps with the second signal block Y2, is formed for a further radio block transmitted immediately after the radio block d. The estimation of the transmitted data units d11, d12, d13, d14, d21, d22, d23, d24 is effected in the same way as described for FIG. 3. The sole difference is that the cyclic transfer matrices C1, C2, C3 are quadratic, and consequently have inverse transfer matrices C1⁻¹, C2⁻¹, C3⁻¹ instead of pseudo-inverse transfer matrices. Then: C1⁻¹*Y1=d1′, C2⁻¹*Y2=d2′ and C3⁻¹*Y3=d3′.

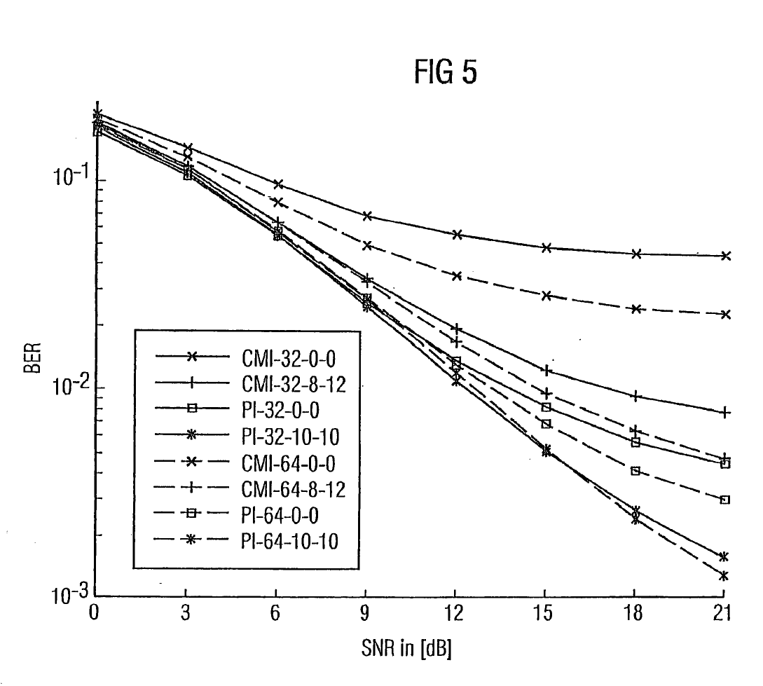

FIG. 5 shows block error rates (BER) for estimated data units as a function of the signal-to-noise ratio (SNR). Pseudo-inverse and inverse matrices were used, together with various signal block sizes and various overlaps between the signal blocks, i.e. between the transfer matrices or the corresponding transmission blocks, as applicable. Here, CMI stands for an inverse cyclic transfer matrix and PI for a pseudo-inverse transfer matrix. The other numbers on each line give, from left to right, the size of the signal blocks together with the number of estimated values of transmitted data units, at the beginning and at the end of an estimated transmission block, which are discarded, i.e. are not used. The detection error for the transmitted data units arises both from the interference effects between data units induced by multi-path propagation and also from noise in the radio channel, for example due to data transmissions from other transmitting stations.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1. Method for estimating data units (d11, d12, d13, d14, d21, d22, d23, d24) transmitted via a radio channel in a radio block (d), by which
the transmitted data units (d11, d12, d13, d14, d21, d22, d23, d24) cause a signal sequence (S) to be received in a receiving station (BS),
the components (K1, K2, K3, K4, K5, K6, K7, K8, K9, K10) of the received signal sequence (S) are assigned in the time-sequence of their receipt to at least a first signal block and a second signal block (X1, X2, X3; Y1, Y2, Y3) and are processed block by block, whereby the signal blocks (X1, X2, X3; Y1, Y2, Y3) overlap in such a way that at least one component (K3, K4, K5, K6, K7, K8) of the received signal sequence (S) belongs to both signal blocks (X1, X2, X3; Y1, Y2, Y3),
and, by reference to the components of both signal blocks (X1, X2, X3; Y1, Y2, Y3), estimated values are determined for the data units (d11, d12, d13, d14, d21, d22, d23, d24) which were transmitted.

2. Method in accordance with claim 1, in which the overlapping of the signal blocks (X1, X2, X3; Y1, Y2, Y3) is effected in such a way that there is at least one of the data units (d13, d14, d21, d22) which was transmitted for which estimated values are determined by reference to each of the two signal blocks (X1, X2, X3; Y1, Y2, Y3).

3. Method in accordance with claim 2, in which after both the estimated values have been determined, the estimated value determined by reference to one of the two signal blocks (d1, d2, d3) is used exclusively for the at least one data unit (d13, d14, d21, d22) which was transmitted.

4. Method in accordance with claim 1, 2 or 3 in which a cyclic transfer matrix (C1, C2, C3) is assigned to each of the signal blocks (Y1, Y2, Y3), and the estimated values are calculated by multiplying the signal blocks (Y1, Y2, Y3) by the relevant inverse transfer matrix.

5. Method in accordance with claim 1, 2 or 3 in which a transfer matrix (H1, H2, H3) with a Töplitz structure and band structure is assigned to each of the signal blocks (X1, X2, X3), and the estimated values are calculated by multiplying the signal blocks (X1, X2, X3) by the relevant pseudo-inverse transfer matrix.

6. Receiving station (BS) with
facilities (SE) for receiving a signal sequence (S) arising from data units (d11, d12, d13, d14, d21, d22, d23, d24) transmitted in a radio block (d),
facilities (P) for assigning the components (K1, K2, K3, K4, K5, K6, K7, k8, k9, K10) of the received signal sequence (S) in the time-sequence of their receipt to at least a first signal block and a second signal block (X1, X2, X3), and with facilities (P) for processing the signal blocks (X1, X2, X3) block by block, whereby the signal blocks (X1, X2, X3) overlap in such a way that at least one component (K3, K4, K5, K6, K7, K8) of the received signal sequence belongs to both signal blocks (X1, X2, X3),
and facilities (P) for determining, by reference to the components of both signal blocks (X1, X2, X3), estimated values for the data units (d11, d12, d13, d14, d21, d22, d23, d24) transmitted.
